(19) United States
(12) Patent Application Publication
(10) Pub. No.: US 2020/0409904 A1
(43) Pub. Date: Dec. 31, 2020

(54) DATA MIGRATION GROUPING, PLANNING AND TRACKING

(71) Applicant: Microsoft Technology Licensing, LLC, Redmond, WA (US)

(72) Inventors: Ashwinikumar Binodnath Jha, Morgan Hill, CA (US); Mario Estevez-Cruz, Mountain View, CA (US); Brad J. Greathouse, Belmont, CA (US)

(21) Appl. No.: 16/457,213

(22) Filed: Jun. 28, 2019

(51) Int. Cl. G06F 16/11; G06F 16/182; G06F 16/178

(52) U.S. Cl. CPC G06F 16/119; G06F 16/178; G06F 16/183

(57) ABSTRACT

The disclosed embodiments provide a system for managing data migration. During operation, the system obtains collaboration data characterizing collaboration among a set of users on a set of files. Next, the system selects, based on the collaboration data, a first subset of users to migrate from a first system for hosting the set of files to a second system for hosting the files based on a high level of collaboration within the first subset of users. The system then determines a first subset of files to migrate for the first subset of users. Finally, the system performs migration of the first subset of files from the first system to the second system based on complexity scores associated with use of the first subset of files by the first subset of users.

### BACKGROUND

### Field

The disclosed embodiments relate to data migration. More specifically, the disclosed embodiments relate to techniques for performing migration grouping, planning and verification.

### Related Art

Data centers and cloud computing systems are commonly used to run applications, provide services, and/or store data for organizations or users. Within the cloud computing systems, software providers deploy, execute, and manage applications and services using shared infrastructure resources such as servers, networking equipment, virtualization software, environmental controls, power, and/or data center space. Moreover, organizations with large numbers of users typically store and/or manage large volumes of data for the users. For example, a company with tens of thousands of employees or users can store over a billion emails, tens of millions of documents, and/or hundreds of millions of access permissions (e.g., read and/or write access) related to the documents.

In turn, migration of data, applications, and/or services associated with large organizations involves significant overhead and/or complexity. For example, conventional migration tools provide “lift and shift” functionality that transfers data from one location, platform, or environment to another. However, these migration tools do not identify or verify compatibility between the data and the location, platform, or environment to which the data is migrated. The migration tools are also unable to identify, detect, or track dependencies or errors associated with the migration of the data. Instead, migration engineers, subject matter experts (SMEs), and/or other users involved in the migration are required to manually identify risks, dependencies, compatibility issues, successful migrations, failed migrations, and/or other complexities associated with migrating the data, before or after the migration is performed.

Moreover, errors or issues with data migration interfere with subsequent use of the data by end users and/or efficient execution of applications, computer systems, platforms, and/or environments to which the data is migrated. For example, a conventional migration tool transfers documents, emails, and/or other data owned by an end user from a source system to a destination system without verifying that all of the data and/or permissions associated with the data were migrated successfully. If permissions associated with a document were not migrated with the document, the owner of the document has to manually re-share the document with other users on the destination system, and the destination system performs additional processing to handle requests from the owner to share the document with the other users.

Continuing with the above example, if one or more documents, emails, and/or files fail to be migrated to the destination system, end users are unable to find or access the missing documents, emails, and/or files on the destination system. Instead, the end users interact with the source and/destination systems to locate or try to recover the documents, emails, and/or files, which reduces the usability of the destination system for the end users and/or involves additional processing by the source and/or destination systems in handling requests for locating or recovering the documents, emails, and/or files.

### BRIEF DESCRIPTION OF THE FIGURES

FIG. 1 shows a schematic of a system in accordance with the disclosed embodiments.

FIG. 2 shows a system for managing data migration in accordance with the disclosed embodiments.

FIG. 3 shows a flowchart illustrating a process of managing data migration in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing migration of data from a source system to a destination system. For example, the disclosed embodiments are used to manage the migration of documents, files, permissions, and/or other data associated with a set of users in an organization from one cloud storage platform, productivity suite, database, and/or enterprise application to another.

More specifically, the users are grouped based on collaboration data that characterizes collaboration or sharing of the data among the users. For example, the collaboration data includes a graph containing a set of nodes representing the users, as well as edges between pairs of nodes that represent collaboration among the users. Each edge is associated with a weight that represents the level of collaboration (e.g., number of shared documents, edits, interactions, etc.) between a corresponding pair of users on data to be migrated. The users are initially grouped by teams, departments, divisions, and/or other portions of an organizational structure for the organization, and each grouping of users is updated to include additional users that have high levels of collaboration other users in the grouping and/or exclude users that have high levels of collaboration with users in other groupings. In turn, a plan for migrating the users' data is generated so that users in each grouping are migrated together, and groupings of users are migrated one at a time.

Complexity scores are also calculated for the users and used to prioritize and/or schedule the migration of the data from the first system to the second system. Each complexity score represents the level of complexity and/or risk associated with migrating data owned or used by a corresponding user from the first system to the second system. The complexity score is calculated as an aggregation and/or combination of components associated with attributes of the data owned or used by the corresponding user. For example, the complexity score is calculated based on a number of documents owned or used by the user that are ineligible for migration, a number of documents owned or used by the user with permissions, a number of shared documents owned or used by the user, a total number of documents owned or used by the user, a number of large documents owned or used by the user, a number of permissions associated with the user, an impact of the user's migration on other users, an impact of the user's migration on documents owned by other users, a number of orphaned files owned or used by the user, and/or an importance of the user.

After complexity scores are calculated for the users, the complexity scores are used to generate averages, medians, percentiles, and/or other aggregations of the complexity scores for the corresponding groupings of users. Complexity scores for individual users and/or aggregated complexity scores for the groupings of users are then used to assess the level of risk associated with performing the migration for the users and/or groupings. The complexity scores and/or aggregated complexity scores are also used to create plans and/or schedules for performing the migration. For example, users within a given grouping and/or different groupings of users are ordered by complexity score, and users and/or groupings with lower complexity scores are scheduled for migration before users and/or groupings with higher complexity scores. In another example, the complexity scores are used to generate a plan and/or instructions for migrating a user and/or grouping of users in a way that mitigates risk and/or problems associated with the migration.

During migration of data for a given user from the first system to the second system, a confidence score is calculated and used to track the status of the migration. For example, the confidence score is calculated based on attributes associated with the status of the migration. The attributes include, but are not limited to, migration of permissions in the data, a number of errors in the migration status, error types in the migration status, a number of documents migrated from the first system to the second system, document types transferred from the first system to the second system, an amount of time associated with migrating the data for the user from the first system to the second system, and/or a number of synchronizations during the migration. When the confidence score reaches a maximum value, the migration is complete, and access to the data by the user is switched from the first system to the second system.

By identifying groupings of users with high levels of collaboration among one another, the disclosed embodiments are able to schedule and/or plan the migration of the users' data along the groupings. As a result, data that is accessible to a given user is more likely to be migrated within a short time span of the user's migration, which minimizes the negative impact of the migration on the user. The use of complexity scores to assess user- and group-level risk associated with the migration further allows the migration schedule and/or plan to be adapted to minimize the risk and/or address issues associated with the risk. At the same time, the use of confidence scores to track the status of the migration for the users allows the success or failure of each migration to be verified and/or issues associated with the migration to be detected.

Moreover, by accounting for dependencies among data used by the users, identifying and characterizing risks associated with the migration, and tracking the status of the migration for individual users, the disclosed embodiments improve the efficiency and scalability of the migration process and reduce the potential for errors during the migration process. In contrast, conventional techniques involve manual tracking and verification of migration statuses and outcomes, which can result in multiple migration attempts that require additional execution or processing by migration tools and/or systems affected by the migrations (e.g., systems to and from which the data is migrated). Consequently, the disclosed embodiments improve computer systems, applications, tools, and/or technologies related to data migration, risk analysis, progress tracking, data storage, and/or collaboration.

### Data Migration Grouping, Planning, and Tracking

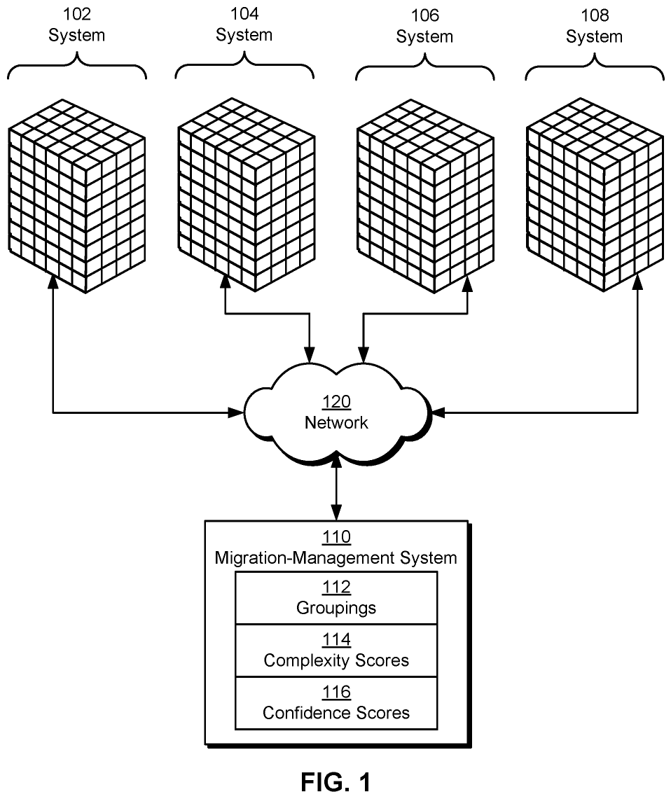

FIG. 1 shows a schematic of a system in accordance with the disclosed embodiments. As shown in FIG. 1, the system includes a migration-management system 110 that coordinates and/or monitors the migration of data among a number of systems 102-108. Systems 102-108 include cloud storage systems, cloud computing systems, productivity suites, databases, enterprise applications, email systems, and/or other collections of hardware and software resources for creating, modifying, storing, sharing, and/or transmitting data associated with a set of users. Systems 102-108 are connected to one another and migration-management system 110 a network 120 such as a local area network (LAN), wide area network (WAN), personal area network (PAN), virtual private network, intranet, mobile phone network (e.g., a cellular network), Wi-Fi network (Wi-Fi® is a registered trademark of Wi-Fi Alliance), Bluetooth (Bluetooth® is a registered trademark of Bluetooth SIG, Inc.) network, universal serial bus (USB) network, Ethernet network, and/or switch fabric.

In one or more embodiments, migration-management system 110 includes functionality to generate groupings 112 of users to migrate from a source system to a destination system. For example, groupings 112 include users from the same team, department, organization, and/or other portion of an organizational hierarchy associated with a company or organization for which the data is to be migrated. In another example, groupings 112 include users with high levels of collaboration among one another.

Migration-management system 110 also includes functionality to carry out migrations of data for users and/or groupings 112 of users based on complexity scores 114 for the users. For example, each complexity score represents the level of complexity and/or risk associated with migrating data owned, used, or stored by a corresponding user from the first system to the second system. As a result, complexity scores 114 can be used to categorize users and/or groupings 112 by levels of risk, prioritize migration of certain users and/or groupings 112 over others, and/or develop plans or techniques to mitigate issues associated with higher-risk users or groupings 112 of users prior to migrating the corresponding data.

Migration-management system 110 further includes functionality to track the progress of migration for individual users and/or groupings 112 of users using confidence scores 116 for the users and/or groupings 112. For example, each confidence score ranges from 0 to 100 and increases as various portions or types of data are successfully migrated for the corresponding user. After a confidence score reaches the maximum value of 100, data for the corresponding user is determined to be successfully migrated, and the user's access to the data is switched from the source system to the destination system. In another example, migration-management system 110 aggregates confidence scores 116 for users in a given grouping into a group-level confidence score that is used to track the progress of data migration for the entire grouping of users. In turn, migration-management system 110 uses groupings 112, complexity scores 114, and confidence scores 116 to plan, track, coordinate, and/or verify migration of data from the source system to the destination system, as described in further detail below.

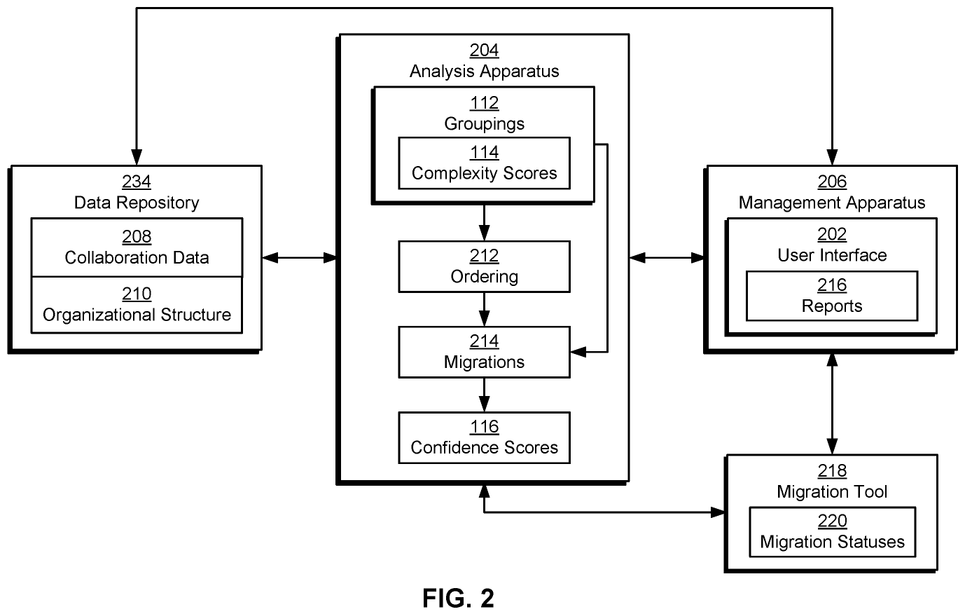

FIG. 2 shows a system for managing data migration (e.g., migration-management system 110 of FIG. 1) in accordance with the disclosed embodiments. As shown in FIG. 2, the system includes an analysis apparatus 204 and a management apparatus 206. Each of these components is described in further detail below.

Analysis apparatus 204 generates groupings 112 of users and/or other entities that interact with data to be migrated from a source system to a destination system (e.g., systems 102-108 of FIG. 1) based on data in a data repository 234. For example, data repository 234 includes a relational database, data warehouse, filesystem, event stream, flat file, and/or another data store. Data in data repository 234 includes, but is not limited to, collaboration data 208 that characterizes collaboration among the users and/or an organization structure 210 associated with the users.

In one or more embodiments, collaboration data 208 includes a graph containing a set of nodes representing the users. Within the graph, edges between pairs of the nodes represent collaboration between the corresponding pairs of users. Each edge is associated with a weight that represents the level of collaboration (e.g., number of shared documents, comments, interactions, etc.) between the corresponding pair of users on data to be migrated from the source system to the destination system. In these embodiments, analysis apparatus 204 uses a clustering technique, graph partitioning technique, and/or another technique to generate groupings 112 of users from the graph in a way that maximizes the number of edges and/or values of edge weights within a given grouping and/or minimizes the number of edges and/or values of edge weights between groupings 112.

In one or more embodiments, organizational structure 210 includes preexisting groupings of employees under different teams, departments, organizations, and/or divisions within a company or other organizational entity. In these embodiments, analysis apparatus 204 initially creates groupings 112 so that each grouping of users contains employees that fall under a corresponding division of the organizational entity. Analysis apparatus 204 also includes functionality to update groupings 112 based on collaboration data 208, so that a user that is grouped under a first division but has a higher level of collaboration with users grouped under a second division is assigned to the grouping for the second division and excluded from the grouping for the first division.

Analysis apparatus 204 also calculates complexity scores 114 associated with users and/or groupings 112 of users. In one or more embodiments, each complexity score represents the level of complexity and/or risk associated with migrating data owned or used by a corresponding user from the first system to the second system. The complexity score is calculated as an aggregation and/or combination of components associated with attributes of the corresponding user and/or data owned or used by the user.

For example, each complexity score ranges in value from 0 to 100 and is calculated as the summation of a number of components, each with a maximum contribution to the complexity score. An example calculation of the complexity score includes the following representation:

| | | Max | Example | |
|---|---|---|---|---|
| Component | Definition | Value | Calculation | Result |
| Total Number Of | Min(Nₜ/ | 5 | 278/ | 1.40 |
| Documents (Nₜ) | Cutoff, 1) * 5 | | 1000 * 5 | |
| Number of Editable | If Nₑ < 10, 0 | 20 | 161/ | 3.20 |
| Documents (Nₑ) | Else Min(Nₑ/ | | 1000 * 20 | |
| | Cutoff, 1) * 20 | | | |
| Number of Shared | If Nₛ < 50, 0 | 5 | 55/ | 0.30 |
| Documents (Nₛ) | Else Min(Nₛ/ | | 1000 * 5 | |
| | Cutoff, 1) * 5 | | | |
| Number of Ineligible | Nᵢ/Nₜ * 5 | 5 | 9/ | 0.15 |
| Documents (Nᵢ) | | | 278 * 5 | |
| Number of Large | Min(Nₗ/ | 10 | 3/ | 1.50 |
| Documents (Nₗ) | Cutoff, 1) * 10 | | 20 * 10 | |
| Number of | Max(Min((Nₚ/ | 15 | (64/ | 0 |
| Permissions | Nₜ − 1)/Cutoff, | | 278 − 1)/ | |
| (Nₚ) | 1), 0) * 15 | | 50 * 15 | |
| Number of | Min(Nₒ/ | 5 | 2/100 * 5 | 0.10 |
| Orphaned | Cutoff, 1) * 5 | | | |
| Files (Nₒ) | | | | |
| User Impact | Any Impact * 10 + | 30 | 10 + 2/ | 16.0 |
| | Min(Users Impacted/ | | 10 * 10 + | |
| | Cutoff, 1) + | | 20/ | |
| | Min(Documents | | 50 * 10 | |
| | Impacted/Cutoff, 1) | | | |
| User Importance | If important user, | 5 | 0 | 0 |
| | 5 Else 0 | | | |

The example representation above includes nine components that are used to calculate a complexity score for a user. The first component represents the total number of documents to be migrated under (e.g., owned, used by, accessible to, stored under, etc.) the user. The total number of documents is divided by a cutoff value to obtain a ratio that is capped at 1 and subsequently multiplied by 5 to obtain a value of the first component. An example calculation involving the first component includes a total number of 278 documents for a user, which is divided by a cutoff of 1000 and multiplied by 5 to obtain a resulting value of 1.40 for the first component.

The example representation above includes a second component representing the number of editable documents to be migrated under the user. If the number of editable documents is less than 10, the value of the second component is set to 0. If the number of editable documents is greater than 10, the value of the second component is calculated by dividing the number of editable documents by a cutoff value to obtain a ratio that is capped at 1 and subsequently multiplied by 20. An example calculation involving the second component includes 161 editable documents divided by a cutoff of 1000 and multiplied by 20 to obtain a value of 3.20 for the second component.

The example representation above includes a third component representing the number of shared documents be migrated under the user. If the number of shared documents is less than 50, the value of the third component is set to 0. If the number of shared documents is greater than 50, the number of shared documents is divided by a cutoff value to obtain a ratio that is capped at 1 and subsequently multiplied by 5 to obtain a value of the third component. An example calculation involving the third component includes 55 shared documents divided by a cutoff of 1000 and multiplied by 5 to obtain a value of 0.30 for the third component.

The example representation above includes a fourth component representing the number of ineligible documents associated with the user. In some embodiments, ineligible documents include documents that are ineligible for migration, such as certain types of documents, documents that exceed a size limit, and/or documents with paths that exceed a certain length. The number of editable documents is divided by the total number of documents, and the result is multiplied by 5 to obtain a value of the fourth component. An example calculation involving the fourth component includes 9 ineligible documents divided by a total number of 278 documents and multiplied by 5 to obtain a value of 0.15 for the fourth component.

The example representation above includes a fifth component representing the number of large documents be migrated under the user. In some embodiments, large documents include documents that exceed a certain size. The value of the fifth component is calculated by dividing the number of large documents by a cutoff value to obtain a ratio that is capped at 1 and subsequently multiplied by 10. An example calculation involving the fifth component includes 3 ineligible documents divided by a cutoff of 20 documents and multiplied by 10 to obtain a value of 1.50 for the fifth component.

The example representation above includes a sixth component representing the number of permissions associated with the user. The number of permissions is divided by the total number of documents to obtain a ratio and subtracting 1 from the ratio (with a lower limit of 0) to ignore permissions associated with owners of the documents. The resulting value is further divided by a cutoff value to obtain another ratio that is capped at 1, which is then multiplied by 15 to obtain a value of the sixth component. An example calculation involving the sixth component includes 64 permissions divided by 278 total documents and subtracting 1 from the result to obtain a value that is capped at 0, which is then divided by a cutoff of 50 and multiplied by 15 to obtain a value of 0 for the sixth component.

The example representation above includes a seventh component representing the number of orphaned files be migrated under the user. In some embodiments, orphaned files include documents that are no longer found in folders in the source system (e.g., because the folders were deleted separately from the documents and/or the documents were removed from the folders). The value of the seventh component is calculated by dividing the number of orphaned files by a cutoff value to obtain a ratio that is capped at 1 and subsequently multiplied by 5. An example calculation involving the seventh component includes 2 orphaned files divided by a cutoff of 100 and multiplied by 5 to obtain a value of 0.10 for the fifth component.

The example representation above includes an eighth component representing the impact of the user's migration on other users. The eighth component includes three sub-components representing any impact of the user's migration on other users or documents, the impact of the user's migration on other users, and the impact of the user's migration on other documents. The first sub-component is set to 0 if the user's migration does not impact any other users or documents and to 10 otherwise. The second sub-component involves the number of users impacted by the user's migration (e.g., the number of users that own files in the user's drive), and the third sub-component involves the number of documents impacted by the user's migration (e.g., the number of documents owned by other users in the user's drive). The second sub-component is calculated by dividing the number of users impacted by the user's migration by a cutoff value to obtain a ratio that is capped at 1 and subsequently multiplied by 10. The third sub-component is calculated by dividing the number of documents impacted by the user's migration by a cutoff value to obtain a ratio that is capped at 1 and subsequently multiplied by 10. An example calculation involving the eighth component includes 8 users and 20 documents impacted by the user's migration. Because the user has a nonzero impact on other users or documents, the first sub-component is set to 10. The second sub-component is obtained by dividing 8 impacted users by a cutoff of 10 and multiplying the result by 10 to obtain a value of 2.0. The third sub-component is obtained by dividing 20 impacted documents by a cutoff of 50 and multiplying the result by 10 to obtain a value of 4.0. The first, second, and third sub-components are then summed to obtain a value of 16.0 for the eighth component.

The example representation above includes a ninth component representing the user's importance. If the user is categorized as an important user, the ninth component is set to 5. If the user is not categorized as an important user, the ninth component is set to 0. An example calculation involving the ninth component includes setting the ninth component to 0 because the user is not categorized as an important user.

Continuing with the example representation above, after values of the nine components are calculated, the values are summed to obtain a complexity score for the user. For example, the example values of 1.40, 3.20, 0.30, 0.15, 1.50, 0, 0.10, 16.0, and 0 are summed to obtain a complexity score of 22.65 out of 100 for the user.

Analysis apparatus 204 additionally includes functionality to aggregate complexity scores 114 for users by groupings 112 to obtain aggregated complexity scores 114 for groupings 112. For example, analysis apparatus 204 calculates a mean, median, percentile, and/or other aggregation from a set of complexity scores 114 for users in a given grouping to obtain an aggregated complexity score for the grouping. In turn, the aggregated complexity score represents an overall measure of complexity or risk in migrating data for the entire grouping.

After groupings 112 and complexity scores 114 are determined, analysis apparatus 204 uses groupings 112 and complexity scores 114 to determine an ordering 212 of migrations 214 of data for the users and/or groupings 112. For example, analysis apparatus 204 orders groupings 112 of users by ascending aggregated complexity scores 114. Within each grouping of users, analysis apparatus 204 also orders users by ascending complexity scores 114.

Analysis apparatus 204 then plans and/or schedules migrations 214 according to ordering 212 of groupings 112 and/or users within each grouping. For example, analysis apparatus 204 schedules migrations 214 of groupings 112 with lower aggregated complexity scores 114 before migrations of groupings 112 with higher aggregated complexity scores 114. Within a given grouping, analysis apparatus 204 schedules migrations 214 of data for users with lower complexity scores 114 before migrations 214 of data for users with higher complexity scores 114. In other words, analysis apparatus 204 generates a plan for migrating the users' data so that users in each grouping are migrated together, and groupings 112 of users are migrated one at a time.

In another example, analysis apparatus 204 creates workflows for performing and/or monitoring migrations 214 based on complexity scores 114 for the users and/or aggregated complexity scores 114 for groupings 112 of users. Each workflow is customized to the level of risk and/or types of risk associated with a corresponding user or grouping of users.

In a third example, analysis apparatus 204 applies a threshold to complexity scores 114 to identify a subset of users with high complexity scores 114 to exclude from a given set of migrations 214 (e.g., migrations 214 of data for a grouping of users to which the subset of users belongs). Analysis apparatus 204 optionally places the excluded users into a “high complexity” grouping of users to be migrated at or near the end of migrations 214 (e.g., after a plan or workflow for migrating high complexity users has been developed).

After migrations 214 are ordered, planned, and/or implemented based on groupings 112 and complexity scores 114, analysis apparatus 204 carries out migrations 214 using a migration tool 218. For example, analysis apparatus 204 identifies, in ordering 212, a first grouping of users to migrate from the source system to the destination system. Analysis apparatus 204 also identifies a subset of users in the first grouping (e.g., users with complexity scores 114 that fall below a threshold) and/or a subset of data associated with the first grouping (e.g., data that is associated with the users and/or “tagged” with a name or identifier of the grouping) to migrate. Analysis apparatus 204 then interfaces with migration tool 218 to execute workflows for migrating files, documents, directories, filesystems, emails, images, audio, video, executables, permissions, and/or other types of data associated with the first grouping from the source system to the destination system. After users and/or data associated with the first grouping are successfully migrated, analysis apparatus 204 identifies, in ordering 212, the next grouping of users to migrate and/or specific users or data to migrate with the next grouping. Analysis apparatus 204 interfaces with migration tool 218 to migrate the next grouping and repeats the process until all users and/or groupings 112 of users have been successfully migrated from the source system to the destination system.

In one or more embodiments, analysis apparatus 204 calculates confidence scores 116 based on migration statuses 220 associated with migrations 214 from migration tool 218 and uses confidence scores 116 to track the progress of migrations 214. In one or more embodiments, each confidence score represents the level of confidence in the successful migration of data associated with a corresponding user from the first system to the second system. The confidence score is calculated as an aggregation and/or combination of components associated with the migration status of the user's data, as obtained from and/or reported by migration tool 218.

For example, each confidence score ranges in value from 0 to 100 and is periodically calculated as the summation of a number of components, each with a maximum contribution to the confidence score. An example calculation of the confidence score includes the following representation:

| | | Max | Example | |
|---|---|---|---|---|
| Component | Definition | Value | Calculation | Result |
| Permissions | If number of permissions | 30 | Number of | 30 |
| transfer rate | transferred/number of | | permissions | |
| | documents transferred >= | | transferred per | |
| | Nₚ/Nₜ, 30 | | document = 0.97 | |
| | Else 0 | | Nₚ/Nₜ = 0.77 | |
| Error | 429 Errors Score + | 15 | 4.75 + −12.10 | 0 |
| Amounts | Non-429 Errors Score | | | |
| Error Types | Tools Errors Score + | 10 | 5 + −0.73 + | 7.31 |
| | API Errors Score + | | 1.06 + 1.98 | |
| | Destination Errors Score + | | | |
| | Other Errors Score | | | |
| Proportion of | Nₜᵣ/Nₜ * 30 | 30 | 101/278 * 30 | 10.90 |
| Documents | | | | |
| Transferred | | | | |
| (Nₜᵣ) | | | | |
| Document | If all document types | 5 | Transferred | 5 |
| Types | have been transferred, 5 | | document | |
| Transferred | Else 0 | | types = 14 | |
| | | | Total document | |
| | | | types = 14 | |
| Time Elapsed | 5/hours elapsed | 5 | 5/66 | 5 |
| Number of | 5 − (number of | 5 | 5 − (267 − | 0 |
| Synchro- | synchronizations − | | 4) * 1.25 | |
| nizations | expected number of | | | |
| | synchronizations) * 1.25 | | | |

The example representation above includes seven components that are used to calculate a confidence score for a user's migration. The first component represents the transfer rate of permissions associated with the user, which is calculated by dividing the number of permissions transferred in the migration by the number of documents transferred in the migration. If the transfer rate is the same as or greater than the total number of permissions associated with the user divided by the total number of documents associated with the user, the first component is set to 30. If the transfer rate is lower than the total number of permissions associated with the user divided by the total number of documents associated with the user, the first component is set to 0. An example calculation involving the first component includes comparing a permissions transfer rate of 0.97 with a value of 0.77 for the total number of permissions associated with the user divided by the total number of documents associated with the user and setting the first component to 30 based on the comparison.

The example representation above includes a second component representing the amount of errors received during the migration. The second component is calculated as a sum of a first score that is calculated based on the number of errors with a HyperText Transfer Protocol (HTTP) status code of 429 and a second score that is calculated based on the number of errors that do not have an HTTP status code of 429. The value of the second component is additionally limited to a range of 0 to 15. An example calculation involving the second component includes summing a positive score of 4.75 for errors related to the 429 status code and a negative score of −12.10 for errors not related to the 429 status code to produce a final value of 0 for the second component.

The example representation above includes a third component representing the types of errors received during the migration. The third component is calculated as a sum of a first score that is calculated based on errors related to one or more migration tools for performing the migration, a second score that is calculated based on errors related to an application programming interface (API) used to perform the migration, a third score that is calculated based on errors related to the destination system to which the data is migrated, and/or a fourth score that is calculated based on other types of errors encountered during the migration. The value of the third component is additionally limited to a range of 0 to 10. An example calculation involving the second component includes summing four scores of 5, −0.73, 1.06, and 1.98 to obtain a value of 7.31 for the second component.

The example representation above includes a fourth component representing the proportion of documents transferred in the migration. The fourth component is calculated by dividing the number of documents transferred by the total number of documents associated with the user and multiplying the result by 30. An example calculation involving the fourth component includes 101 transferred documents divided by a total number of 278 documents and multiplied by 30 to obtain a value of 10.90 for the fourth component.

The example representation above includes a fifth component representing document types transferred in the migration. If all document types associated with the user have been migrated, the value of the fifth component is set to 5. If one or more document types associated with the user have not been migrated, the value of the fifth component is set to 0. An example calculation involving the fifth component includes comparing 14 document types transferred in the migration to 14 total document types associated with the user and setting the value of the fifth component to 5 based on the comparison.

The example representation above includes a sixth component representing the time lapsed in the migration. The sixth component is calculated by dividing 5 by the number of hours that have lapsed since the start of the migration to produce a value that ranges from 0 to 5. As a result, the sixth component of the confidence score is inversely proportional to the amount of time required to perform the migration, after the migration exceeds one hour. An example calculation involving the sixth component involves dividing 5 by 66 hours that have lapsed in the migration to obtain a value of 0.08 for the sixth component.

The example representation above includes a seventh component representing the number of synchronizations (e.g., file synchronizations, folder synchronizations, initial synchronizations, final synchronizations, etc.) in the migration. The seventh component has a range from 0 to 5 and is calculated by multiplying the difference between the number of expected synchronizations and the number of actual synchronizations in the migration by 1.25 and subtracting the result from 5. An example calculation involving the seventh component involves subtracting 4 expected synchronizations from 267 actual synchronizations and multiplying the result by 1.25 to produce a value of 262, which is subtracted from 5 with a floor of 0 to obtain a final value of 0 for the seventh component.

Continuing with the example representation above, after values of the seven components are calculated, the values are summed to obtain a confidence score for the user. For example, the example values of 30, 0, 7.31, 10.90, 5, 0.08, and 0 are summed to obtain a confidence score of 53.29 out of 100 for the user.

After the confidence score for a user reaches the maximum value (e.g., 100) and/or within a margin of the maximum value, migration of data for the user is deemed to be complete, and the user is able to access the data on the destination system instead of the source system. Conversely, a stall or decrease in the confidence score over time indicates a potential problem with the user's migration.

As with complexity scores 114, analysis apparatus 204 includes functionality to aggregate confidence scores 116 for users by groupings 112 to track the progress of migrations 214 on a per-grouping basis. For example, analysis apparatus 204 calculates a mean, median, percentile, and/or other aggregation from a set of confidence scores 114 for users in a given grouping to obtain an aggregated confidence score for the grouping. In turn, the aggregated confidence score represents an overall measure of confidence or completeness in migrating data for the entire grouping.

In some embodiments, management apparatus 206 provides a user interface 202 that allows migration engineers, subject matter experts (SMEs), and/or other users involved in performing the migration to view reports 216 related to groupings 112, ordering 212, migrations 214, migration statuses 220, complexity scores 114, and/or confidence scores 116. In turn, reports 216 allow the users to identify, create, and/or modify groupings 112 of users to migrate together; generate plans and/or workflows for carrying out migrations 214; assess and/or mitigate risk associated with migrating individual users and/or groupings 112 of users; and/or track the progress or status of migrations 214 on the user, grouping, or organization level.

For example, user interface 202 includes a visual representation of a graph of collaboration data 208 for various users and/or groupings 112 of users, as well as user-interface elements for changing the granularity of the graph, exploring the graph, and/or generating or defining groupings 112 based on nodes and/or edges in the graph. In another example, user interface 202 includes a complexity score for a user, as well as a breakdown of the complexity score into different components and calculations of the components from corresponding attributes. In a third example, user interface 202 includes an aggregated complexity score for a grouping of users, along with a list of complexity scores 114 for the users and user-interface elements for sorting the list by complexity scores 114 and/or other attributes of the users. In a fourth example, user interface 202 includes an up-to-date confidence score for a user for which migration has started, as well as a breakdown of the confidence score into different components and calculations of the components from corresponding attributes. A migration engineer, SME, and/or other user involved in monitoring or performing the migration thus uses user interface 202 to monitor the progress or status of the migration for each user. In a fifth example, user interface 202 includes an aggregated confidence score for a grouping of users, along with a list of confidence scores 116 for the users and user-interface elements for sorting the list by confidence scores 116 and/or other attributes of the users.

By identifying groupings of users with high levels of collaboration among one another, the disclosed embodiments are able to schedule and/or plan the migration of the users' data along the groupings. As a result, data that is accessible to a given user is more likely to be migrated within a short time span of the user's migration, which minimizes the negative impact of the migration on the user. The use of complexity scores to assess user- and group-level risk associated with the migration further allows the migration schedule and/or plan to be adapted to minimize the risk and/or address issues associated with the risk. At the same time, the use of confidence scores to track the status of the migration for the users allows the success or failure of each migration to be verified and/or issues associated with the migration to be detected.

Moreover, by accounting for dependencies among data used by the users, identifying and characterizing risks associated with the migration, and tracking the status of the migration for individual users, the disclosed embodiments improve the efficiency and scalability of the migration process and reduce the potential for errors during the migration process. In contrast, conventional techniques involve manual tracking and verification of migration statuses and outcomes, which can result in multiple migration attempts that require additional execution or processing by migration tools and/or systems affected by the migrations (e.g., systems to and from which the data is migrated). Consequently, the disclosed embodiments improve computer systems, applications, tools, and/or technologies related to data migration, risk analysis, progress tracking, data storage, and/or collaboration.

Those skilled in the art will appreciate that the system of FIG. 2 may be implemented in a variety of ways. First, analysis apparatus 204, management apparatus 206, and data repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of techniques may be used to determine groupings 112, complexity scores 114, ordering 212, and/or confidence scores 116. For example, complexity scores 114 and/or confidence scores 116 may be generated based on different sets of criteria and/or using a variety of formulas. In another example, complexity scores 114 and/or confidence scores 116 are generated by one or more machine learning models based on features associated with the corresponding users and/or migration statuses 220. In a third example, groupings 112 and/or orderings of users to be migrated are generated based on criteria and/or priorities associated with the users' seniorities within an organization, account tiers associated with the users, usage of data and/or features associated with the source and/or destination systems by the users, and/or other attributes.

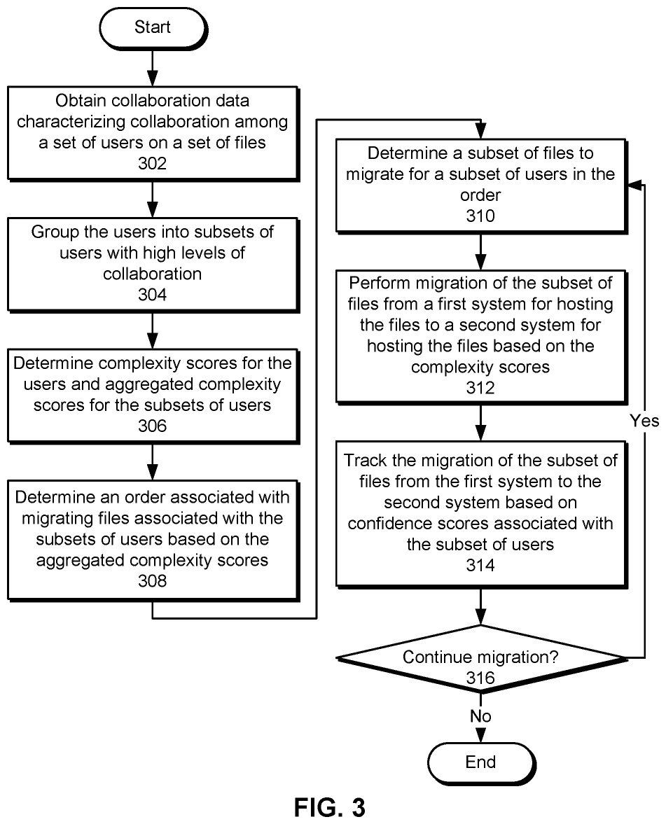

FIG. 3 shows a flowchart illustrating a process of managing data migration in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, collaboration data characterizing collaboration among a set of users on a set of files is obtained (operation 302). For example, the collaboration data includes a graph containing a set of nodes representing the users and edges between pairs of the nodes representing collaboration between the corresponding pairs of users on one or more files. Each edge is assigned a weight representing the level or extent of collaboration between the corresponding users.

Next, the users are grouped into subsets of users with high levels of collaboration (operation 304). For example, an organizational structure associated with the users are used to group users under different portions (e.g., teams, departments, division, etc.) of the organizational structure. A user that is outside a given portion of the organizational structure but that has a high level of collaboration with the users in the portion is optionally added to the grouping of users associated with the portion. Conversely, a user that is in a given portion of the organizational structure is optionally excluded from the grouping of users associated with the portion when the user has a low level of collaboration with other users in the portion.

After the users are grouped into different subsets based on the organizational structure and/or collaboration data, complexity scores for the users and aggregated complexity scores for the subsets of users are determined (operation 306). For example, a complexity score is calculated for each user based on a number of documents that are ineligible for migration, a number of documents with permissions, a number of shared documents, a total number of documents, a number of large documents, a number of permissions, an impact on other users, an impact on documents owned by other users, a number of orphaned files, and/or an importance of the user. Complexity scores for users in a given grouping are then combined into a mean, median, percentile, and/or other aggregated complexity score representing the level of complexity and/or risk associated with migrating data for the grouping.

An order associated with migrating files associated with the subsets of users is also determined based on the aggregated complexity scores (operation 308). For example, the subsets of users are ordered by ascending aggregated complexity score, so that less risky or complex groupings of users are migrated before more risky or complex groupings of users.

A subset of files to migrated for a subset of users in the order is determined (operation 310), and migration of the subset of files from a first system for hosting the files to a second system for hosting the files is performed based on the complexity scores (operation 312). For example, the subset of files includes files that are owned and/or accessed by the users, files that reside in the users' “drives” within the first system, and/or files that are tagged with a name or identifier for the subset of users. Data for the subset of users is then migrated based on an ordering of the user by ascending complexity score, so that less risky or complex data or users are migrated before more risky or complex data or users. The complexity scores are also, or instead, used to exclude one or more users highly complex or risky users and the associated data from the current migration.

The migration of the subset of files from the first system to the second system is further tracked based on confidence scores associated with the subset of users (operation 314). For example, a confidence score is calculated for each user at the start of a migration of the user's data based on attributes associated with a migration status associated with the migration. The attributes include migration of permissions in the data, a number of errors in the migration status, error types in the migration status, a number of documents migrated from the first system to the second system, document types transferred from the first system to the second system, an amount of time associated with migrating data for the user from the first system to the second system, and/or a number of synchronizations. The confidence score is also updated regularly during the migration to track the progress of the user's migration. When the confidence score for the user reaches a maximum value and/or within a margin of the maximum value, access to the data by the user is switched from the first system to the second system.

Migration of data may continue (operation 316) for remaining subsets of users and/or data. More specifically, after a given subset of users and/or files is migrated from the first system to the second system, another subset of files is determined for the next subset of users in the order (operation 310), and migration of the files is performed based on complexity scores for the users (operation 312) and tracked based on confidence scores for the users (operation 314). Operations 310-314 may be repeated until all files and/or users have been migrated from the first system to the second system.

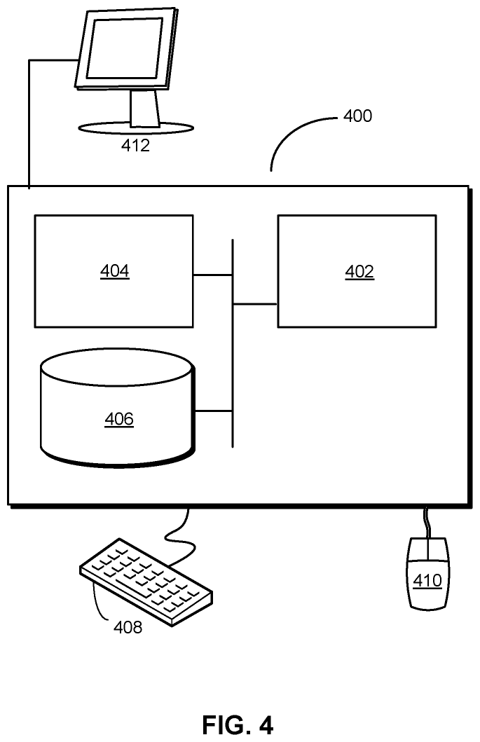

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for managing data migration. The system includes an analysis apparatus and a management apparatus, one or more of which may alternatively be termed or implemented as a module, mechanism, or other type of system component. The analysis apparatus obtains collaboration data characterizing collaboration among a set of users on a set of files. Next, the analysis apparatus selects, based on the collaboration data, a first subset of users to migrate from a first system for hosting the set of files to a second system for hosting the files based on a high level of collaboration within the first subset of users. The analysis apparatus then determine a first subset of files to migrate for the first subset of users. Finally, the analysis apparatus and/or management apparatus perform migration of the first subset of files from the first system to the second system based on complexity scores associated with use of the first subset of files by the first subset of users. The analysis apparatus and/or management apparatus additionally track the migration of the first subset of files from the first system to the second system based on confidence scores associated with the first subset of users.

In addition, one or more components of computer system 400 may be remotely located and connected to the other components over a network. Portions of the present embodiments (e.g., analysis apparatus, management apparatus, data repository, source system, destination system, etc.) may also be located on different nodes of a distributed system that implements the embodiments. For example, the present embodiments may be implemented using a cloud computing system that manages, coordinates, and/or tracks the migration of data from a first remote system to a second remote system.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining collaboration data characterizing collaboration among a set of users on a set of files;
selecting, by one or more computer systems based on the collaboration data, a first subset of users to migrate from a first system for hosting the set of files to a second system for hosting the files based on a high level of collaboration within the first subset of users;
determining, by the one or more computer systems, a first subset of files to migrate for the first subset of users; and
performing, by the one or more computer systems, migration of the first subset of files from the first system to the second system based on complexity scores associated with use of the first subset of files by the first subset of users.

2. The method of claim 1, further comprising:
tracking the migration of the first subset of files from the first system to the second system based on confidence scores associated with the first subset of users.

3. The method of claim 2, wherein tracking the migration of the first subset of files from the first system to the second system based on the confidence scores associated with the first subset of users comprises:
updating a confidence score for a user based on attributes associated with a migration status associated with migrating data for the user from the first system to the second system; and
when the confidence score for the user reaches a maximum value, switching access to the data by the user from the first system to the second system.

4. The method of claim 3, wherein the attributes comprise at least one of:
migration of permissions in the data;
a number of errors in the migration status;
error types in the migration status;
a number of documents migrated from the first system to the second system;
document types transferred from the first system to the second system;
an amount of time associated with migrating the data for the user from the first system to the second system; and
a number of synchronizations.

5. The method of claim 1, wherein performing the migration of the first subset of files from the first system to the second system based on the complexity scores associated with the use of the first subset of files by the first subset of users comprises:
calculating a complexity score for a user based on attributes associated with data for the user to be migrated from the first system to the second system.

6. The method of claim 5, wherein the attributes comprise at least one of:
a number of documents that are ineligible for migration;
a number of documents with permissions;
a number of shared documents;
a total number of documents;
a number of large documents;
a number of permissions;
an impact on other users;
an impact on documents owned by other users;
a number of orphaned files; and
an importance of the user.

7. The method of claim 1, wherein performing the migration of the first subset of files from the first system to the second system based on the complexity scores associated with the use of the first subset of files by the first subset of users comprises:
determining an ordering of the first subset of users associated with performing the migration of the first subset of files from the first system to the second system based on the complexity scores.

8. The method of claim 1, further comprising:
selecting, based on the collaboration data, a second subset of users to migrate from the first system to the second system; and
after migration of the first subset of files from the first system to the second system is complete, initiating migration of a second subset of files for the second subset of users from the first system to the second system.

9. The method of claim 8, further comprising:
determining an order of migration of the first subset of files before the second subset of files based on a first aggregated complexity score calculated from the complexity scores for the first subset of users and a second aggregated complexity score calculated from the complexity scores for the second subset of users.

10. The method of claim 1, wherein selecting the first subset of users to migrate from the first system to the second system based on the high level of collaboration within the first subset of users comprises:
identifying the first subset of users within a portion of an organizational structure for the set of users; and
adding one or more users with the high level of collaboration with the portion of the organizational structure to the first subset of users.

11. The method of claim 10, wherein selecting the first subset of users to migrate from the first system to the second system based on the high level of collaboration within the first subset of users further comprises:
excluding one or more additional users within the portion of the organizational structure from the first subset of users based on a low level of collaboration between the one or more additional users and other users in the first subset of users.

12. The method of claim 1, wherein the collaboration data comprises:
a set of nodes representing the set of users; and
a set of edges between pairs of nodes in the set of nodes, wherein the set of edges represents collaboration among the set of users.

13. A system, comprising:
one or more processors; and
memory storing instructions that, when executed by the one or more processors, cause the system to:
obtain collaboration data characterizing collaboration among a set of users on a set of files;
select, based on the collaboration data, a first subset of users to migrate from a first system for hosting the set of files to a second system for hosting the files based on a high level of collaboration within the first subset of users;
determine a first subset of files to migrate for the first subset of users; and
perform migration of the first subset of files from the first system to the second system based on complexity scores associated with use of the first subset of files by the first subset of users.

14. The system of claim 13, wherein the memory further stores instructions that, when executed by the one or more processors, cause the system to:
track the migration of the first subset of files from the first system to the second system based on confidence scores associated with the first subset of users.

15. The system of claim 14, wherein tracking the migration of the first subset of files from the first system to the second system based on the confidence scores associated with the first subset of users comprises:
updating a confidence score for a user based on attributes associated with a migration status associated with migrating data for the user from the first system to the second system; and
when the confidence score for the user reaches a maximum value, switching access to the data by the user from the first system to the second system.

16. The system of claim 15, wherein the attributes comprise at least one of:
migration of permissions in the data;
a number of errors in the migration status;
error types in the migration status;
a number of documents migrated from the first system to the second system;
document types transferred from the first system to the second system;
an amount of time associated with migrating the data for the user from the first system to the second system; and
a number of synchronizations.

17. The system of claim 13, wherein performing the migration of the first subset of files from the first system to the second system based on the complexity scores associated with the use of the first subset of files by the first subset of users comprises:
calculating the complexity scores for the first subset of users based on attributes associated with data for the first subset of users to be migrated from the first system to the second system; and
determining an ordering of the first subset of users associated with performing the migration of the first subset of files from the first system to the second system based on the complexity scores.

18. The system of claim 17, wherein the attributes comprise at least one of:
a number of documents that are ineligible for migration;
a number of documents with permissions;
a number of shared documents;
a total number of documents;
a number of large documents;
a number of permissions;
an impact on other users;
an impact on documents owned by other users;
a number of orphaned files; and
an importance of a user.

19. The system of claim 13, wherein the memory further stores instructions that, when executed by the one or more processors, cause the system to:
select, based on the collaboration data, a second subset of users to migrate from the first system to the second system;
determine an order of migration of the first subset of files before the second subset of files based on a first aggregated complexity score calculated from the complexity scores for the first subset of users and a second aggregated complexity score calculated from the complexity scores for a second subset of users; and
after migration of the first subset of files from the first system to the second system is complete, initiate migration of a second subset of files for the second subset of users from the first system to the second system.

20. A non-transitory computer-readable storage medium storing instructions that when executed by a computer cause the computer to perform a method, the method comprising:
obtaining collaboration data characterizing collaboration among a set of users on a set of files;
selecting, based on the collaboration data, a first subset of users to migrate from a first system for hosting the set of files to a second system for hosting the files based on a high level of collaboration within the first subset of users;
determining a first subset of files to migrate for the first subset of users;
performing migration of the first subset of files from the first system to the second system based on complexity scores associated with use of the first subset of files by the first subset of users; and
tracking the migration of the first subset of files from the first system to the second system based on confidence scores associated with the first subset of users.
